(19) United States
(12) Patent Application Publication
(10) Pub. No.: US 2009/0292854 A1
(43) Pub. Date: Nov. 26, 2009

(54) USE OF BOND OPTION TO ALTERNATE BETWEEN PCI CONFIGURATION SPACE

(76) Inventor: Ken KHOO, Singapore (SG)

Correspondence Address: O2MICRO INC;C/O MURABITO, HAO & BARNES LLP, TWO NORTH MARKET STREET, THIRD FLOOR, SAN JOSE, CA, 95113, US

(21) Appl. No.: 12/125,610

(22) Filed: May 22, 2008

(51) Int. Cl. G06F 13/36

(52) U.S. Cl. 710/312

(57) ABSTRACT

An adaptor for adapting one of a first device complying with a first bus, and a second device complying with a second bus to a Peripheral Component Interconnect Express (PCIe) interface. The adaptor comprises a first bridge for interconnecting the first bus with the PCIe bus, a second bridge for interconnecting the second bus with the PCIe bus, and a PCIe core coupled to the two bridges. A bond option signal is coupled to the two bridges and the PCIe core for enabling one of the two bridges, and one of the two bridges is configured by the PCIe core.

### TECHNICAL FIELD

The invention relates to an adaptor for interconnecting different kinds of buses, and more particularly, to an adaptor using a bond option signal to alternate between Peripheral Component Interconnect (PCI) configuration spaces.

### BACKGROUND ART

Input/Output (I/O) buses serve as expressways for transferring data between different modules or devices in a computer system. There exist various bus standards in modern market, such as Industry Standard Architecture (ISA), Accelerated Graphics Port (AGP), Peripheral Component Interconnect (PCI), PCI eXtended (PCI-X), PCI Express (PCIe), Universal Serial Bus (USB), IEEE 1394 (FireWire), CardBus and ExpressCard.

Some of the mainstream bus standards are briefly introduced hereinafter. For example, PCI bus was originally developed as a local bus expansion slot for the Personal Computer (PC) bus, i.e. ISA bus, and was coined as the PCI Local Bus. It is a single parallel data bus. PCIX bus builds on the foundation of the PCI bus, and offers greater performance and faster throughput. PCI Express (PCIe) bus is an improvement on the PCI bus. PCIe technology makes fundamental innovation in bus architecture while maintaining complete software compatibility. PCIe bus uses two Low Voltage Differential Signal (LVDS) pairs to provide full duplex communication: one pair for transmitting, and one pair for receiving. The two LVDS pairs compose a serial, point-to-point wired, individually clocked lane, which allows faster throughput than parallel PCI and PCI-X. PCI, PCI-X, and PCIe bus standards are all maintained and distributed by an international organization, i.e., Peripheral Component Interconnect Special Interest Group (PCI-SIG).

CardBus standard is a 32-bit version of the legacy 16-bit Personal Computer Memory Card International Association (PCMCIA) PC card standard. The PCMCIA is known as Revision 2 (R2), while the CardBus is Revision 3 (R3). The CardBus standard is designed as backward compatible with the PCMCIA (R2) standard, so both CardBus cards and R2 cards can be used in a single slot.

A host system may comprise a plurality of devices complying with different buses, which are designed to cooperate with the host system. However, the bus standards mentioned hereinabove are not compatible with each other. Accordingly, in order to make a device of one bus work under another bus properly, bridges or controllers are developed.

A PCIe-PCI/PCI-X bridge in the prior art interconnects a PCIe bus with a PCI/PCI-X bus, as well as increases expansion capability beyond the limitation of a single PCIe bus. As such, a PCI/PCI-X device is adapted to a PCIe interface. A PCI-CardBus controller in the prior art provides a bridge between a PCI bus and a CardBus bus for insertion of 32-bit CardBus cards or legacy 16-bit R2 cards. As such, a CardBus device is adapted to a PCI interface.

In a PCIe based computer system, all computer Input/Output (I/O) devices including the PCIe-PCI/PCI-X bridge and the PCI-CardBus controller need to be configured by their own configuration spaces. A configuration space of a device is made up of a set of registers and a configuration space header occupies the first place. The configuration space header contains information required to determine the characteristics and purpose of a data packet sent from the device. By reading corresponding configuration space headers, a Basic Input/Output System (BIOS) and an operating system (OS) can detect the devices, and then allocate resources to them and drive them accordingly. For being universally applied, the configuration space headers of the devices should comply with standards set out by an accepted organization, such as the PCI-SIG. The PCIe-PCI/PCI-X bridge is defined as a Type 1 configuration space header in PCI-SIG “PCI Local Bus Specification Revision 3.0”, “PCI Express Base Specification Revision 1.1” and “PCI Express to PCI/PCI-X Bridge Specification Revision 1.0”. The PCI-CardBus controller is defined as a Type 2 configuration space header in PCI-SIG “PCI Local Bus Specification Revision 3.0” and “PCI to PCMCIA Cardbus Bridge Register Description—Yenta release 2.3” available from Intel. On the one hand, PCIe-PCI/PCI-X bridges and PCI-CardBus controllers are configured by different types of configuration space headers respectively. On the other hand, definitions of pins between interfaces of various buses are different. In the prior art, the PCIe-PCI/PCI-X bridge and the PCI-CardBus controller need to be designed and manufactured separately. It will be inconvenient and costly to adapt devices of more than one bus to a certain interface of a certain bus by using more than one adaptor.

### SUMMARY OF THE INVENTION

It is therefore an object of the present invention to provide an apparatus or method for adapting devices of different buses to an interface of a certain bus with low cost and high efficiency.

In order to achieve the above object, the present invention provides an adaptor for adapting one of a first device complying with a first bus, and a second device complying with a second bus to a Peripheral Component Interconnect Express (PCIe) interface. The adaptor comprises a first bridge for interconnecting the first bus with the PCIe bus, a second bridge for interconnecting the second bus with the PCIe bus, and a PCIe core coupled to the two bridges. A bond option signal is coupled to the two bridges and the PCIe core for enabling one of the two bridges, and one of the two bridges is configured by the PCIe core.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a block diagram showing a PCIe-based computer system, in accordance with one embodiment of the present invention.

FIG. 2 is a block diagram showing an adaptor for interconnecting one of two different buses with PCIe bus, in accordance with one embodiment of the present invention.

FIG. 3 is a block diagram showing an adaptor for interconnection between PCIe bus and PCI bus, or between PCIe bus and CardBus bus, in accordance with one embodiment of the present invention.

FIG. 4 is a block diagram showing the PCIe-PCI bridge shown in FIG. 3, in accordance with one embodiment of the present invention.

FIG. 5 is a block diagram showing the CardBus logic shown in FIG. 3, in accordance with one embodiment of the present invention.

FIG. 6 is a block diagram showing an adaptor for interconnection between PCIe bus and PCI-X bus, or between PCIe bus and CardBus bus, in accordance with another embodiment of the present invention.

FIG. 7 is a flowchart showing a method for manufacturing an adaptor capable of adapting a PCI device or a CardBus device to a PCIe interface, in accordance with one embodiment of the present invention.

### DESCRIPTION OF THE EMBODIMENT

Reference will now be made in detail to the embodiments of the present invention, use bond option to alternate between PCI configuration space. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

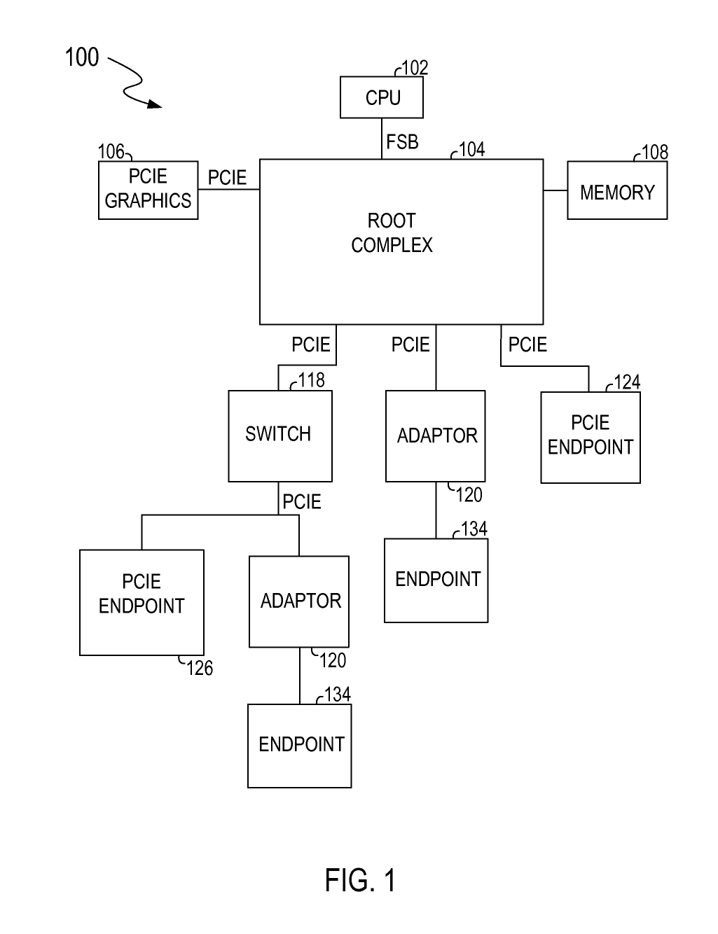

Referring to FIG. 1, a PCIe-based computer system 100 according to one embodiment of the present invention is illustrated. The computer system 100 complies with the PCIe bus standard, and most devices or modules of the computer system 100 are coupled with each other through PCIe buses. As shown in FIG. 1, the computer system 100 generally comprises regular modules, such as a central processing unit (CPU) 102, a root complex 104, a graphics card 106, a memory 108, a switch 118, PCIe endpoints 124 and 126. The CPU 102 interprets instructions and processes data contained in computer programs.

The root complex 104 coupled to the CPU 102 through a front side bus (FSB), which is also called system bus, processor bus, or memory bus, comprises more than one PCIe interface such that multiple switches and endpoints can be coupled or cascaded to the interfaces of the root complex 104. The root complex 104 interconnects all the devices and modules in the computer system 100, initializes and manages the PCIe fabric. As shown in FIG. 1, the root complex 104 couples the memory 108 and the graphics card 106 to the CPU 102. The memory 108 temporarily stores the instructions and data, and provides the stored data or instructions to the CPU 102. The graphics card 106 makes the computer system 100 capable of displaying images on a display (not shown). In addition, the root complex 104 generates transaction requests on behalf of the CPU 102, translates the memory-mapped PCIe configuration space accesses from the CPU 102 to PCIe configuration transactions.

The switch 118 operates as a collection of virtual PCI-to-PCI bridges, and is coupled to the root complex 104 through one PCIe interface. The switch 118 provides peer-to-peer communication between different endpoints. Two or more ports are coupled to allow data packets to be routed from one port to another. For example, the PCIe endpoint 126 and an adaptor 120 can be coupled to two ports of the switch 118 so as to allow data packets to be routed from one port to another. As such, through the switch 118, data are routed between multiple PCIe links. The switch 118 also provides a fan-out capability to allow new devices to be coupled to the computer system 100. The PCIe endpoint 124 coupled to the root complex 104 and the PCIe endpoint 126 coupled to the switch 118 are both associated with I/O devices and terminate the PCIe hierarchy.

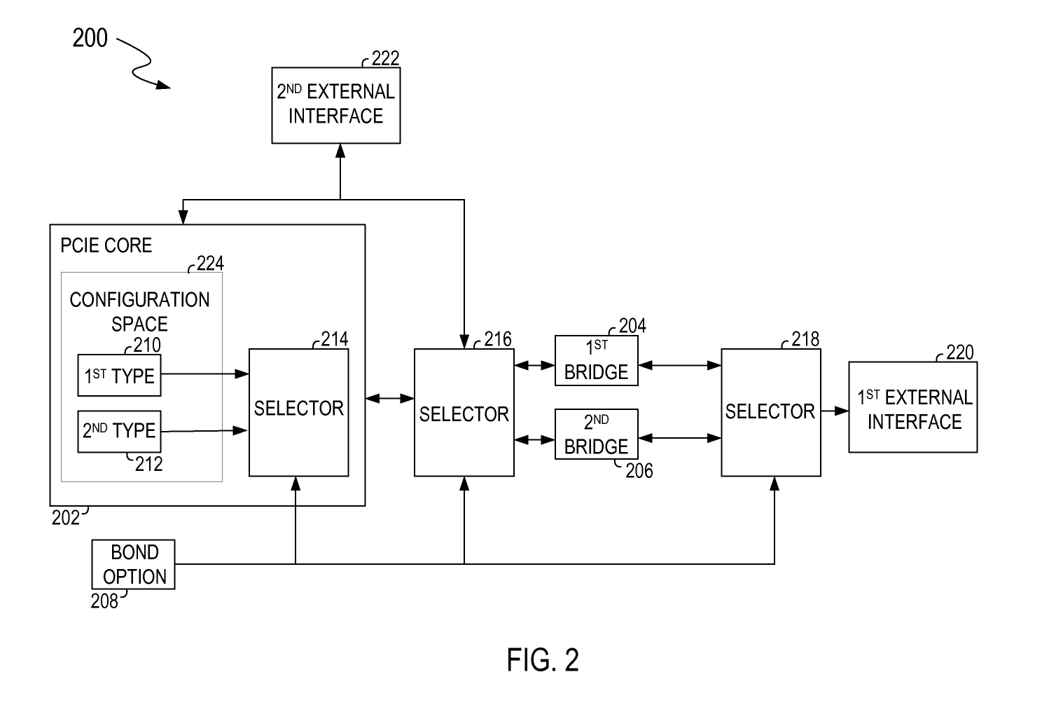

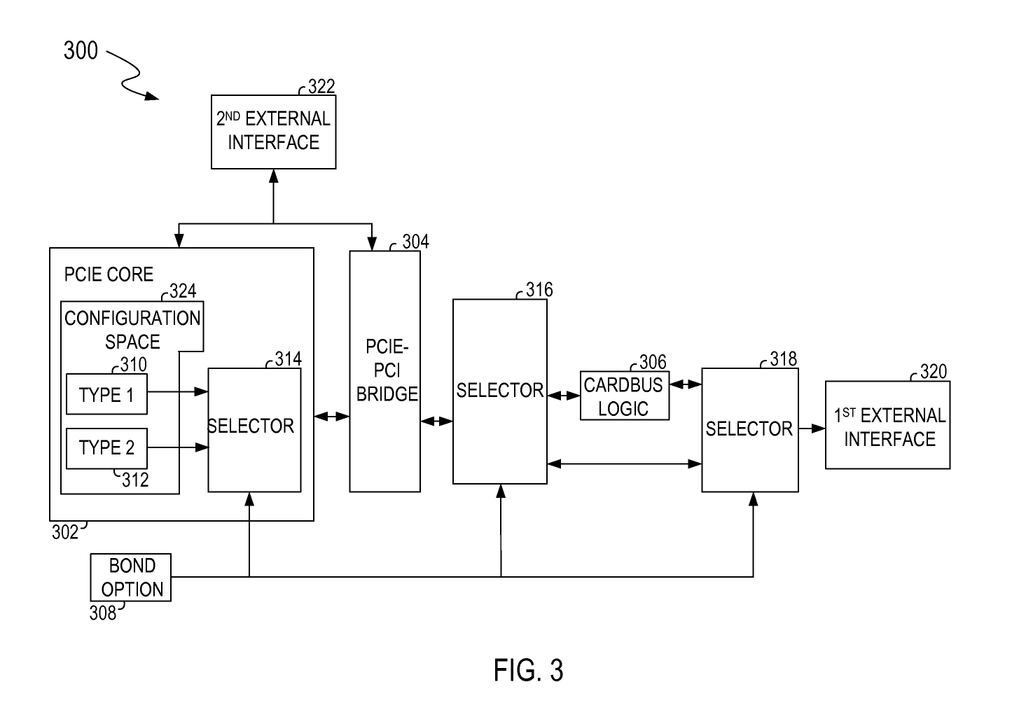

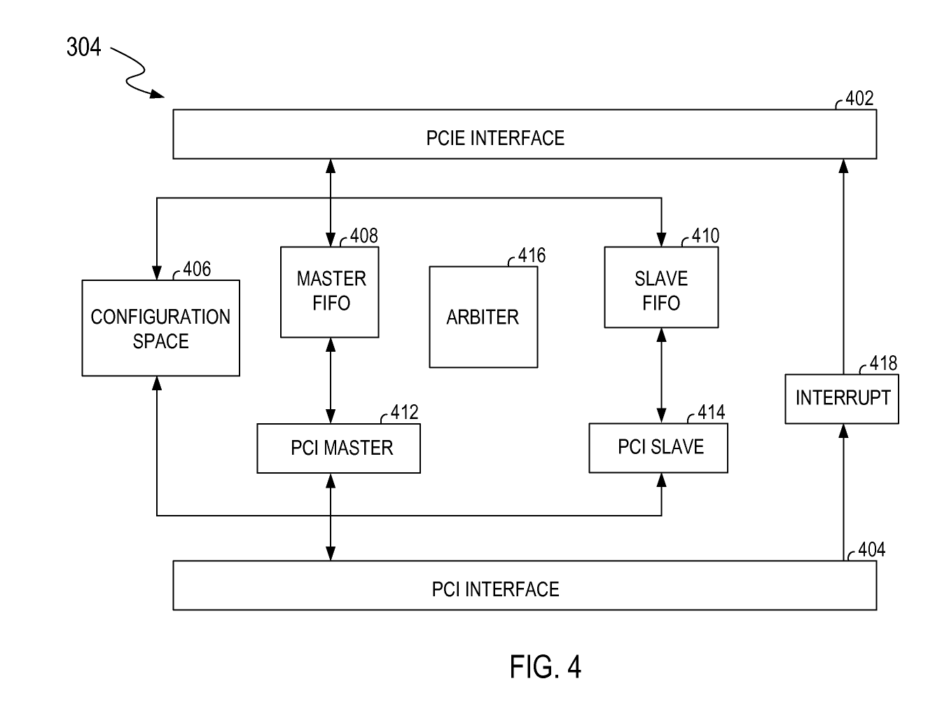

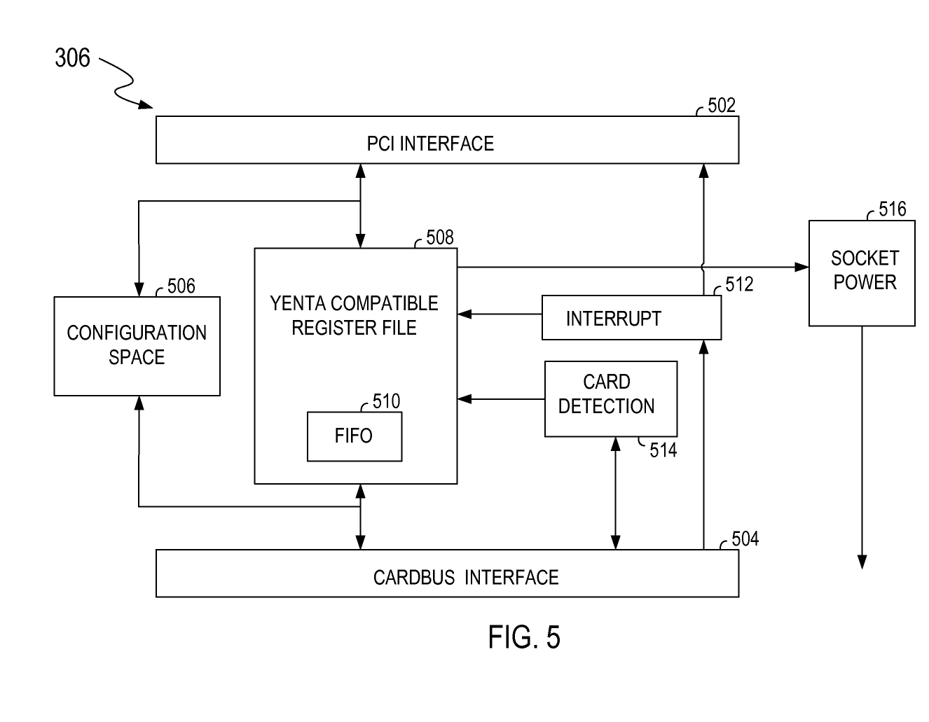

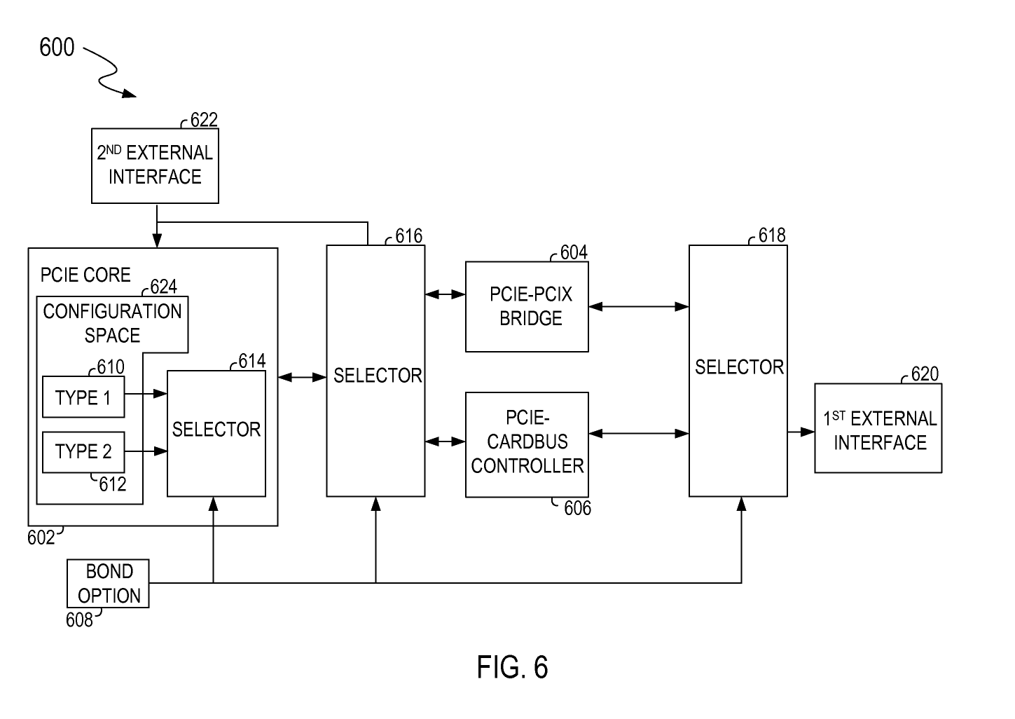

As shown in FIG. 1, the adaptor 120 is coupled to the switch 118, and will be described in detail with reference to FIG. 2, FIG. 3, FIG. 4, FIG. 5 and FIG. 6. The adaptor 120 is coupled to the root complex 104 or the switch 118 through a PCIe interface for adapting a device complying with other bus, such as PCI, CardBus, PCI-X, to the PCIe bus. In one embodiment, when the endpoint 134 is a PCI device, the adaptor 120 is used as a PCIe-PCI bridge for communication between the PCI device (the endpoint 134) and the PCIe bus. In another embodiment, when the endpoint 134 is a CardBus device, the adaptor 120 is used as a PCIe-CardBus controller for communication between the CardBus device and the PCIe bus. In the prior art, the PCIe-PCI bridge and the PCIe-CardBus controller are two different products or integrated circuit (IC) chips. In accordance with embodiments of the present invention, the functions of the PCIe-PCI bridge and the PCIe-CardBus controller are both integrated into the adaptor 120. Through a bond option signal, one of the functions is selected so as to interconnect the PCI bus with the PCIe bus, or interconnect the CardBus bus with the PCIe bus.

Referring to FIG. 2, an adaptor 200 according to one embodiment of the present invention is illustrated. The adaptor 200 can be installed in a PCIe-based host computer system to function as does the adaptor 120 discussed above with reference to FIG. 1 and to couple an endpoint to the host computer system. The bus standard that the endpoint complies with, such as PCI bus and Cardbus bus, may be various. The adaptor 200 can be adapted to comply with varied buses. During manufacturing the adaptor 200, a bond option signal can be used to determine which bus the adaptor 200 complies with. Therefore, the adaptor 200 can comply with the bus of the endpoint for interconnecting the endpoint with a PCIe bus of the host computer system, when the adaptor 200 is installed in the host computer system.

The adaptor 200 comprises a PCIe core 202, a first bridge 204, a second bridge 206, a first selector 214, a second selector 216 and a third selector 218. The bond option signal 208 is coupled to the first, the second and the third selector 214, 216 and 218. The PCIe core 202 comprises a configuration space 224 coupled to the first selector 214. The configuration space 224 comprises a first type configuration space header 210 and a second type configuration space header 212, as well as other configuration space registers such as command register, status registers, address register, control register, interrupt register and so on (not shown). By writing corresponding configuration space registers according to the configuration space header 210 or 212, the adaptor 200 is detected, numbered, assigned required resources and thus configured. The configuration space 224 configures the adaptor 200 such that the operating system (OS) of the host computer system can make out the operating mode of the adaptor 200.

In accordance with one embodiment of the present invention, the configuration space headers 210 and 212 allow the adaptor 200 to identify and control their corresponding devices. In one embodiment, the first type configuration space header 210 configures the first bridge 204 for interconnection between a first bus and the PCIe bus, and the second type configuration space header 212 configures the second bridge 206 for interconnection between a second bus and the PCIe bus. The first type configuration space header 210 and the second type configuration space header 212 are both coupled to the first selector 214, and the bond option signal 208 controls the first selector 214 to choose one of the first type configuration space header 210 and the second type configuration space header 212.

The bond option signal 208 is an external signal of the adaptor 200 for determining which bus in the adaptor 200 will be interconnected with a PCIe bus of the host computer system. After the bond option signal 208 determines the bus of the adaptor 200 and the adaptor 200 is installed in the host computer system, signals of configuration information from the PCIe core 202 can be transferred to the first bridge 204 or the second bridge 206 through the first selector 214 and the second selector 216.

The second selector 216 is coupled to the first bridge 204 and the second bridge 206 for enabling one of the bridges 204 and 206 in response to the bond option signal 208. In one embodiment, the first bridge 204 is configured according to the first type configuration space header 210 for controlling interconnection between the first bus and the PCIe bus. Signals complying with the first bus and signals complying with the PCIe can be inter-converted through the first bridge 204. Similarly, the second bridge 206 is configured according to the second type configuration space header 212 for controlling interconnection between the second bus and the PCIe bus. Signals complying with the second bus standard and signals complying with the PCIe standard can be inter-converted through the second bridge 206.

Further, the bond option signal 208 is coupled to the third selector 218 for enabling a first external interface 220. The first external interface 220 is coupled to the third selector 218 for receiving a first device complying with the first bus or a second device complying with the second bus.

The adaptor 200 further comprises a second external interface 222 coupled to the PCIe core 202, the first bridge 204 and the second bridge 206 for coupling the adaptor 200 to the PCIe fabric of the host computer system. In accordance with one embodiment of the present invention, the adaptor 200 is coupled to a root complex or a switch of the host computer system through the second external interface 222. Once the first bridge 204 or the second bridge 206 is configured according to the first type configuration space header 210 or the second type configuration space header 212, through the second external interface 222, the PCIe fabric of the host computer system can communicate with the first device complying with the first bus or the second device complying with the second bus coupled to the first external interface 220.

For example, when the first device complying with the first bus is chosen to communicate with the host computer system, the first device complying with the first bus is coupled to the first external interface 220 and the second external interface 222 is applied to the host computer system. In addition, the first type configuration space header 210 in the PCIe core 202 is chosen by means of the bond option signal during manufacture. Basic Input/Output System (BIOS) and operating system (OS) detect the first device complying with the first bus and configure the first bridge 204 according to the first type configuration space header 210, and then the first bridge 204 is ready for interconnecting the first device complying with the first bus with the host computer system. As such, the first device complying with the first bus can communicate with the host computer system. In another situation, when the second device complying with the second bus is chosen to communicate with the host computer system, the second bridge 206 is configured in response to the second type configuration space header 212 for interconnecting the second device complying with the second bus with the host computer system.

Taking the first bus as an example, the bridge 204 is configured by BIOS and OS according to the first type configuration space header 210 in the PCIe core 202. When the host computer system is turned on, the BIOS detects and initializes the bridge 204 of the adaptor 200 in the host computer system. Command register in the PCIe core 202 is set by the BIOS. Then, the BIOS sets all memories and I/O windows as required to allow child devices behind the first bridge 204 to receive required resources. Otherwise, wait for the OS to set default memory and I/O windows for the child devices. Subsequently, the BIOS sets corresponding base addresses, interrupt registers, and other registers in the configuration space 224. After the BIOS code finishes running, the OS begins enumerating the first bridge 204.

During enumeration, a PCIe bus driver scans the PCIe bus and finds the first bridge 204. The PCIe bus driver determines whether the first bridge 204 has been configured by the BIOS by checking whether the I/O and memory as system resources are properly assigned, and whether the Bus Master bits are set in the command register of the configuration space 224. Once the first bridge 204 is configured by the BIOS, the PCIe bus driver will defer to the BIOS and will not change the bridge configuration. If the first bridge 204 is not configured by the BIOS because of an error, or because the first bridge 204 is not detected when the BIOS code was running, the PCIe bus driver assigns default resources. Then the PCIe bus driver enables the first bridge 204, and scans the buses behind it. When the first device complying with the first bus is behind the first bridge 204, for example, the PCIe bus driver passes resources to the first device complying with the first bus from the resources allocated to the first bridge 204.

Referring back to FIG. 2, the adaptor 200 has three selectors, the first selector 214, the second selector 216 and the third selector 218. The first selector 214 selects one of the configuration space headers 210 or 212 in response to the bond option signal 208, and transmits the signal of the configuration information of the PCIe core 202. The bond option signal 208 indicates that the endpoint complying with the first or the second bus is to be interconnected with the host computer system complying with the PCIe bus. The second selector 216 coupled to the PCIe core 202 receives the signal of the configuration information, and enables the bridge 204 or 206 in response to the bond option signal 208. The third selector 218 coupled to the bridges 204 and 206 is used for transferring signals between the enabled bridge 204 or 206 and the first external interface 220 such that the first device complying with the first bus or the second device complying with the second bus is adapted to be coupled to the host computer system which complies with the PCIe bus.

It should be noted that the bond option signal 208 is used to choose the first or the second bus during the manufacture of the adaptor 200. After the adaptor 200 is packaged from an integrated circuit (IC) die to an IC chip, the bridge function of the adaptor 200 (either for the first bus or for the second bus) is determined and also the type of configuration space header is decided accordingly. Two bridge functions are provided in the adaptor 200, and one of the two functions can be chosen just at the last step of manufacture by setting the bond option signal. The risk of overstocking one specific bridge device can be reduced, and the supply can be balanced according to instant order requirement. As such, costs of manufacture of the bridges or controllers can be reduced.

Referring to FIG. 3, an adaptor 300 for interconnection between a PCIe bus and a PCI bus or between a PCIe bus and a CardBus bus, in accordance with one embodiment of the present invention, is illustrated. The PCIe core 302 plays the same role as the PCIe core 202 shown in FIG. 2 does. The PCIe core 302 comprises a configuration space 324 coupled to a selector 314. The PCIe core 302 comprises a first type configuration space header, e.g., a Type 1 configuration space header 310 and a second type configuration space header, e.g., a Type 2 configuration space header 312. The Type 1 configuration space header 310 is used for a PCIe-PCI bridge device as defined in the PCI-SIG “PCI Express Base Specification Revision 1.1” and “PCI Express to PCI/PCI-X Bridge Specification Revision 1.0.” The Type 2 configuration space header 312 is used for a PCIe-CardBus controller as defined in the PCI-SIG “PCI Local Bus Specification Revision 3.0” and “PCI to PCMCIA CardBus Bridge Register Description—Yenta specification release 2.3” available from Intel corporation.

In this embodiment, the adaptor 300 has a PCIe-PCI bridge 304 configured according to the Type 1 configuration space header 310. The adaptor 300 further comprises a CardBus logic 306 which associates with the PCIe-PCI bridge 304 to function as a PCIe-CardBus controller configured according to the Type 2 configuration space header 312. The CardBus logic 306 is coupled to the PCIe-PCI bridge 304. As such, through the combination of the PCIe-PCI bridge 304 and the CardBus logic 306, the adaptor 300 is capable of interconnecting a CardBus device with the PCIe bus of a host computer. The PCIe-PCI bridge 304 and the CardBus logic 306 will be described specifically hereinafter in FIG. 4 and FIG. 5, respectively.

Under the condition that the adaptor 300 will be installed in a PCIe-based host computer system for coupling a PCI device to the host computer, a bond option signal 308 will be sent to the selectors 314, 316 and 318 for making the adaptor 300 to operate as a PCIe-PCI bridge. When the adaptor 300 is installed in the host computer, the PCI device is coupled to an external interface 320 of the adaptor 300 for communication with the PCIe bus of the host computer system. Through the selector 314, the Type 1 configuration space header 310 is selected to configure the PCIe-PCI bridge 304. A signal of configuration information of the PCIe core 302 is transferred through the selector 314 to the PCIe-PCI bridge 304. The selector 316 coupled to the PCIe-PCI bridge 304 transfers PCI signals. Through a selector 318 and the external interface 320, the PCI device can be read or be written.

Likewise, under the condition where the adaptor 300 will be installed in the PCIe-based host computer system for coupling a CardBus device to the host computer, the bond option signal 308 will be sent to the selectors 314, 316 and 318 for making the adaptor 300 operate as a PCIe-CardBus controller. When the adaptor 300 is installed in the host computer system, the CardBus device is coupled to the external interface 320 of the adaptor 300 for communication with the PCIe bus of the host computer system. Through the selector 314, the Type 2 configuration space header 312 is selected to configure the PCIe-PCI bridge 304 and the CardBus logic 306 according to the bond option signal 308. A signal of configuration information of the PCIe core 302 is transferred through the selector 314 to the PCIe-PCI bridge 304 which interconnects PCI bus with PCIe bus. The CardBus logic 306 is enabled by the selector 316 for interconnecting the PCI bus with the CardBus bus. Through the selector 318 coupled to the CardBus logic 306 and the external interface 320, the CardBus device can be read or be written.

With a proper bond option signal 308 as described above, in accordance with embodiments of the present invention, the adaptor 300 is capable of being configured either as the PCIe-PCI bridge or the PCIe-CardBus controller. The PCI device or the CardBus device can be adaptable to the PCIe system through the adaptor 300.

Those skilled in the art will recognize that the adaptor 300 can be formed or manufactured as an IC die which will subsequently be packaged into an IC chip. After the adaptor 300 is packaged from the IC die to the IC chip, the bridge function of the adaptor 300 either as the PCIe-PCI bridge or the PCIe-CardBus controller is determined and also the type of configuration space header is decided accordingly. In conclusion, two bridge functions are available in the single adaptor 300, but only one of the two bridge functions is enabled depending on the last step of the manufacture of the adaptor 300—setting a proper bond option signal 308.

Referring to FIG. 4, the PCIe-PCI bridge 304 is illustrated, in accordance with one embodiment of the present invention. The PCIe-PCI bridge 304 comprises a PCIe interface 402 and a PCI interface 404, for adapting a PCI device to a PCIe system. The PCIe-PCI bridge 304 is configured according to a configuration space 406 for interconnecting PCIe bus with PCI bus, when Type 1 configuration space header is applied. In one embodiment, the configuration space 406 is the configuration space 324 shown in FIG. 3.

When the PCI device is to be written to, PCIe data needs to be converted into PCI data. PCIe data packets are decoded and transferred into a master First In First Out register (FIFO) 408. And then, a PCI master 412 executes correct PCI cycle, depending on command (configuration, I/O or memory) and data. Finally PCI data come out from the PCI interface 404. Similarly, when the PCI device is to be read, PCI data needs to be converted into PCIe data. PCI slave 414 checks if cycle triggered by the PCI device belongs to the memory space at the PCIe interface 402. If so, data are transferred into the slave FIFO 410, and then are packetized into PCIe data packets which are sent out through the PCIe interface 402.

The PCIe-PCI bridge 304 further comprises arbiter 416, interrupt 418 and some sideband signals. The arbiter 416 is used to make sure that only one cycle appears at the PCI bus when master cycle and slave cycle happen at the same time. The interrupt 418 is used to offer an alert signal when interrupt happens.

Referring to FIG. 5, the CardBus logic 306 in the FIG. 3 is illustrated, in accordance with one embodiment of the present invention. The CardBus logic 306 is used for coupling a PCI bus coupled to a PCI interface 502 to a CardBus bus coupled to a CardBus interface 504, which is used for insertion of CardBus cards. When a CardBus device is coupled to the interface 504, a card detection 514 identifies device type. BIOS detects the CardBus device and configures the CardBus logic 306 according to configuration space 506. Through a Yenta compatible register file 508 which comprises a FIFO 510, PCI signals from the PCI interface 502 pass over configuration, memory or I/O transactions to the CardBus interface 504.

The CardBus logic 306 further comprises interrupt 512, socket power 516, and other sideband signals such as Clkrunn and Cstschg. The interrupt 512 is used to handle an interrupt. The socket power 516 applies correct power to the CardBus device. The PCI bus driver is responsible for allocating PCI resources to the CardBus logic 306 in a process similar to the allocation of resources to the PCIe-PCI bridge 304.

Referring to FIG. 6, an adaptor 600 for interconnecting PCIe bus with PCIX bus, or PCIe bus with CardBus bus, in accordance with another embodiment of the present invention, is illustrated. PCIX bus is built upon the same architecture, protocols, signals, and connector as traditional PCI bus, so the design elements for the conventional PCI bus can be used in the adaptor 600.

As shown in FIG. 6, the adaptor 600 comprises a PCIe core 602, a PCIe-PCIX bridge 604, a PCIe-CardBus controller 606, and a bond option signal 608. The PCIe core 602 plays the same role as the PCIe core 202 shown in FIG. 2 or the PCIe core 302 of the adaptor 300 shown in FIG. 3. The PCIe core 602 comprises a configuration space 624. The configuration space 624 comprises Type 1 configuration space header 610 and Type 2 configuration space header 612. The Type 1 configuration space header 610 is used to configure the PCIe-PCIX bridge 604. The Type 2 configuration space header 612 is used to configure the PCIe-CardBus controller 606. The Type 1 configuration space header 610 is designed to comply with standards defined in the PCI-SIG “PCI Express Base Specification Revision 1.1” and “PCI Express to PCI/PCI-X Bridge Specification Revision 1.0” for a PCIe-PCI/PCI-X bridge. The Type 2 configuration space header 612 is designed to comply with standards defined in the “PCI Local Bus Specification Revision 3.0” by PCI-SIG and “PCI to PCMCIA CardBus Bridge Register Description—Yenta specification release 2.3” available from Intel corporation, for a CardBus controller.

The bond option signal 608 is coupled to selectors 614, 616 and 618 for determining whether PCIX bus or CardBus bus will be interconnected with PCIe bus of a host computer system. In response to the bond option signal 608, one of the Type 1 configuration space header 610 and the Type 2 configuration space header 612 is chosen. When the adaptor 600 is installed in the host computer system, a signal of configuration information from the PCIe core 602 can be transmitted through the first selector 614. Also, corresponding one of the PCIe-PCIX bridge 604 and the PCIe-CardBus controller 606 is chosen to receive the signal of configuration information through the second selector 616.

The PCIe-PCIX bridge 604 is capable of interconnecting PCIe bus with PCIX bus in response to the Type 1 configuration space header 610. It should be noted that the speed of PCIX bus is faster (133 MHz and more) than the speed of PCI bus and CardBus bus (33 MHz). The PCIe-CardBus controller 606 is capable of interconnecting PCIe bus with CardBus bus in response to the Type 2 configuration space header 612.

Under a first set of conditions, the PCIe-PCIX bridge 604 is configured by the signal of configuration information according to the Type 1 configuration space header 610, thus the adaptor 600 can interconnect PCIX bus with PCIe bus. The adaptor 600 further comprises a first interface 620 and a second interface 622. Once a PCIX device is coupled to the first external interface 620, and the second external interface 622 is coupled to a PCIe bus host computer system, the PCIX device can be read or written by the PCIe system.

Under a second set of conditions, the PCIe-CardBus controller 606 is configured by the signal of configuration information according to the Type 2 configuration space header 612, and the adaptor 600 can interconnect CardBus bus with PCIe bus. When a CardBus device is coupled to the first external interface 620, and the second external interface 622 is coupled to the PCIe bus host computer system, the PCIX device can be read or written by the PCIe system.

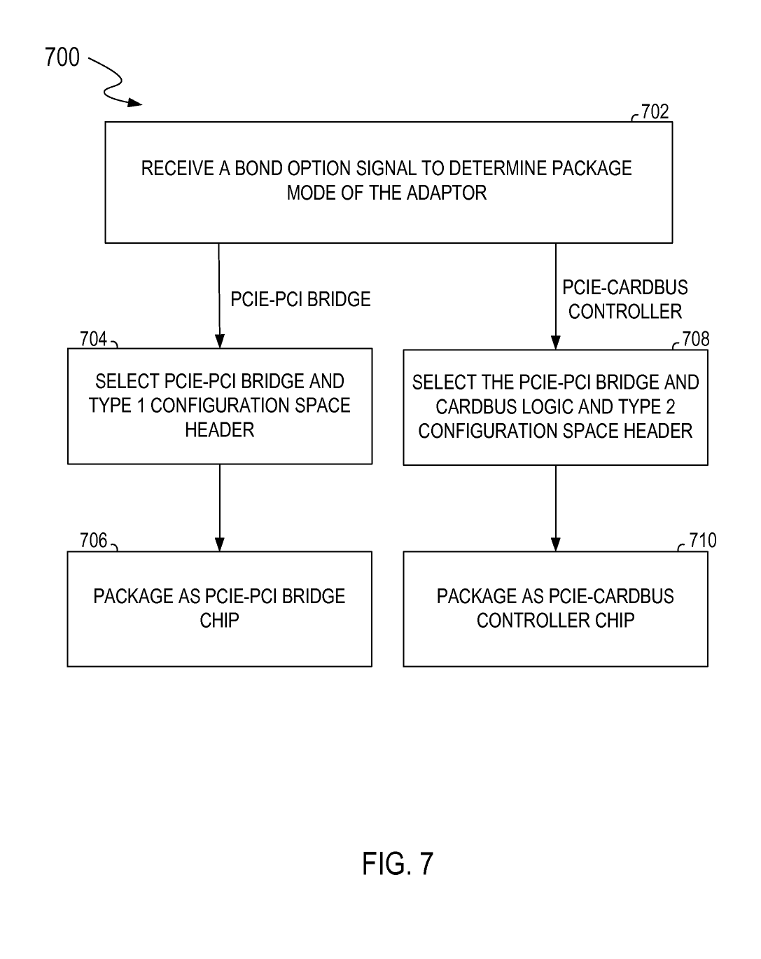

Referring to FIG. 7, a method 700 for producing an adaptor according to one embodiment of the present invention is illustrated. By means of the method 700, the adaptor is packaged and configured to function as a PCIe-PCI bridge for adapting a PCI device to a PCIe interface, or as a PCIe-CardBus controller for adapting a CardBus device to the PCIe interface. After being packaged as a chip, the adaptor can be installed in a PCIe-based host computer system and a second external interface of the adaptor is coupled to a PCIe interface of the host computer system, which may be one of the slots in a motherboard of the host computer system. The PCI device or CardBus device can be coupled to a first external interface of the adaptor. The PCIe bus is considered as a master system bus.

The adaptor comprises a PCIe-PCI bridge for interconnecting PCI bus with PCIe bus, and a CardBus logic for interconnecting PCI bus with CardBus bus.

The combination of the PCIe-PCI bridge and the CardBus logic can be used for interconnecting CardBus bus with PCIe bus. In response to a bond option signal, one of only the PCIe-PCI bridge or the PCIe-PCI bridge with the CardBus logic will be enabled. The adaptor further comprises a PCIe core for configuring the PCIe-PCI bridge and the CardBus logic such that the adaptor is functioning properly when the adaptor is installed in the host computer. Actually, a configuration space in the PCIe core configures the PCIe-PCI bridge and the CardBus logic when the BIOS and OS of the host computer system are executed. The configuration space comprises a Type 1 configuration space header for configuring the PCIe-PCI bridge, and a Type 2 configuration space header for configuring the PCIe-PCI bridge associated with the CardBus logic. The adaptor can be formed or manufactured as an IC die. During the manufacturing process of the adaptor, a bond option signal is applied to the IC die for enabling corresponding components and configuration space of the adaptor. Then, the IC die will subsequently be packaged into an IC chip. The packaged chip will be recognized as only one of the PCIe-PCI bridge and the PCIe-CardBus controller by BIOS and OS of the host computer system.

As shown in FIG. 7, at 702, package mode of the adaptor is determined. The package mode of the adaptor is determined by applying the bond option signal to the adaptor. For example, the adaptor can receive either a high level bond option signal or a low level bond option signal. In response to the high level bond option signal, a PCIe-PCI bridge chip package mode is chosen, and the adaptor is determined to be formed or packaged as a PCIe-PCI bridge chip interconnecting PCI bus with PCIe bus. On the alternative, in response to the low level bond option signal, a PCIe-CardBus controller chip package mode is chosen, and the adaptor is determined to be formed or packaged as a PCIe-CardBus controller chip interconnecting CardBus bus with PCIe bus. The bond option signal is received by three selectors of the adaptor such that corresponding components and configuration space of the adaptor are chosen and enabled.

According to the package mode determined at 702, the following steps are introduced in two lines. If the adaptor die is determined to be formed as the PCIe-PCI bridge, then blocks 704 and 706 are executed for interconnecting PCI bus with PCIe bus. Otherwise, if the adaptor die is determined to be formed as the PCIe-CardBus controller, blocks 708 and 710 are executed for interconnecting CardBus bus with PCIe bus.

At 704, in response to, for example, the high level bond option signal, a PCIe-PCI bridge and a Type 1 configuration space header in a PCIe core are selected. A first selector is enabled by the high level bond option signal so as to transfer Type 1 configuration information of the PCIe core corresponding to the Type 1 configuration space header. At the same time, the PCIe-PCI bridge is enabled by a second selector and a third selector in response to the high level bond option signal.

At 706, the adaptor die is packaged into a PCIe-PCI bridge chip. After the adaptor die is packaged, the adaptor will be recognized as a PCIe-PCI bridge by BIOS and OS of the host computer system when the adaptor is installed in the host computer system.

When the adaptor is installed in the host computer system, the PCI device can be coupled to the first external interface of the adaptor and the second external interface of the adaptor is coupled to the PCIe interface of the host computer system. The configuring procedure is done by the BIOS and OS of the host computer system, through writing corresponding configuration space registers in the PCIe core of the adaptor according to the Type 1 configuration space header. At first, the BIOS detects and initializes the adaptor as a PCIe-PCI bridge. And, the BIOS sets command register in the PCIe core of the adaptor. Then, the BIOS sets all memory and I/O windows as required to allow the PCI device behind the adaptor to receive required resources. Subsequently, the BIOS sets base addresses, interrupt registers, and so on. Finally, after the BIOS code finishes running, the OS begins enumerating the adaptor. After configured, the PCI device coupled to the first external interface is adapted to the PCIe interface. Through the adaptor, PCI bus and PCIe bus are interconnected.

At 708, in response to, for example, the low level bond option signal, the first selector selects a Type 2 configuration space header in the PCIe core and transfers corresponding Type 2 configuration information of the PCIe core. Both the PCIe-PCI bridge and the CardBus logic are enabled so as to work together for interconnecting CardBus bus with PCIe bus.

At 710, the adaptor die is packaged into a PCIe-CardBus controller chip. After the adaptor die is packaged, the adaptor will be recognized as a PCIe-CardBus controller by the BIOS and OS of the host computer system when the adaptor is installed in the host computer system.

When the adaptor is installed in the host computer system, the CardBus device can be coupled to a first external interface of the adaptor, and the second external interface of the adaptor is coupled to the PCIe interface of the host computer system. The PCIe-PCI bridge and the CardBus logic are configured by the BIOS and OS of the host computer system according to the Type 2 configuration space header. The configuring procedure for them is similar to that for the PCIe-PCI bridge chip, and is not described repeatedly herein for clarity. The CardBus logic is configured for interconnecting PCI bus with CardBus bus. As such, the combination of the PCIe-PCI bridge and the CardBus Logic is capable of interconnecting CardBus bus with PCIe bus.

After configured, the CardBus device coupled to the first external interface is adapted to the PCIe interface. Through the adaptor, CardBus bus and PCIe bus are interconnected.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An adaptor for adapting one of a first device complying with a first bus and a second device complying with a second bus to a Peripheral Component Interconnect Express (PCIe) interface, said adaptor comprising:
a first bridge for interconnecting said first bus with a PCIe bus;
a second bridge for interconnecting said second bus with said PCIe bus; and
a PCIe core coupled to said first bridge and said second bridge,
wherein a bond option signal is coupled to said first bridge, said second bridge and said PCIe core for enabling one of said first and second bridges, wherein said one of said first and second bridges is configured by said PCIe core.

2. The adaptor as claimed in claim 1, wherein said PCIe core further comprises:
a first type configuration space header for configuring said first bridge;
a second type configuration space header for configuring said second bridge; and
a first selector coupled to said bond option signal, said first and second type configuration space headers for selecting and transferring configuration information of said PCIe core from one of said first and second type configuration space headers in response to said bond option signal.

3. The adaptor as claimed in claim 2, wherein said first type configuration space header is Type 1 configuration space header as defined in “PCI Local Bus Specification Revision 3.0”, “PCI Express Base Specification Revision 1.1” and “PCI Express to PCI/PCI-X Bridge Specification Revision 1.0”.

4. The adaptor as claimed in claim 2, wherein said second type configuration space header is Type 2 configuration space header as defined in “PCI Local Bus Specification Revision 3.0” and “PCI to PCMCIA CardBus Bridge Register Description—Yenta specification release 2.3”.

5. The adaptor as claimed in claim 1, wherein said first bridge is a PCIe-PCI bridge for interconnecting a Peripheral Component Interconnect (PCI) bus with said PCIe bus.

6. The adaptor as claimed in claim 5, wherein said second bridge comprises a CardBus logic for interconnecting CardBus bus with said PCI bus.

7. The adaptor as claimed in claim 1, wherein said first bridge is a PCIe-PCIX bridge for interconnecting a Peripheral Component Interconnect eXtended (PCIX) bus and said PCIe bus.

8. The adaptor as claimed in claim 1, further comprising:
a second selector coupled to said PCIe core, said bond option signal, said first bridge and said second bridge for enabling said one of said first and second bridges in response to said bond option signal.

9. The adaptor as claimed in claim 1, further comprising:
a third selector coupled to said bond option signal, said first bridge and said second bridge for coupling said one of said first bridge and said second bridge to a first external interface, wherein said first external interface is coupled to said third selector for coupling one of said first device and said second device to said one of said first bridge and said second bridge.

10. The adaptor as claimed in claim 1, further comprising:
a second external interface coupled to said PCIe core and said first and second bridges for coupling said adaptor to said PCIe interface.

11. A method for manufacturing an adaptor which is capable of adapting one of a Peripheral Component Interconnect (PCI) device and a CardBus device to a Peripheral Component Interconnect Express (PCIe) interface, said method comprising:
determining a package mode by a bond option signal for interconnecting one of a PCI bus or a Cardbus bus with a PCIe bus; and
packaging said adaptor.

12. The method as claimed in claim 11, further comprising:
selecting a PCIe-PCI bridge of said adaptor and a Type 1 configuration space header in a PCIe core of said adaptor in response to said bond option signal.

13. The method as claimed in claim 11, further comprising:
selecting said PCIe-PCI bridge, a CardBus logic coupled to said PCIe-PCI bridge of said adaptor, and a Type 2 configuration space header in said PCIe core of said adaptor in response to said bond option signal.

14. The method as claimed in claim 11, further comprising:
receiving said bond option signal by a first selector coupled to said Type 1 and Type 2 configuration space headers in said PCIe core for selecting one of said Type 1 and Type 2 configuration space headers.

15. The method as claimed in claim 11, further comprising:
receiving said bond option by a second selector coupled to said PCIe core, said PCIe-PCI bridge and said CardBus logic for enabling said CardBus logic.

16. A computer system that uses Peripheral Component Interconnect Express (PCIe) interfaces, comprising:
a Central Processing Unit (CPU) for managing a plurality of devices of said computer system;
a root complex having a plurality of said PCIe interfaces, coupled to said CPU; and
an adaptor coupled to said root complex through one of said plurality of PCIe interfaces, using a bond option signal for adapting one of a first device complying with a first bus and a second device complying with a second bus to said PCIe interface.

17. The computer system as claimed in claim 16, wherein said adaptor comprising:
a first bridge coupled to said bond option signal for being selected and enabled by said bond option signal and interconnecting said first bus with a PCIe bus;
a second bridge coupled to said bond option signal for being selected and enabled by said bond option signal and interconnecting said second bus with said PCIe bus; and
a PCIe core coupled to said bond option signal, said first bridge and said second bridge for configuring one of said first bridge and said second bridge for interconnecting one of said first bus and said second bus with said PCIe.

18. The computer system as claimed in claim 16, further comprising: a switch coupled between said root complex and said adaptor for interconnecting said adaptor with said root complex.

19. The computer system as claimed in claim 16, wherein said first bus is Peripheral Component Interconnect (PCI) bus.

20. The computer system as claimed in claim 16, wherein said second bus is CardBus bus.
